(19) United States
(12) Patent Application Publication
(10) Pub. No.: US 2002/0181701 A1
(43) Pub. Date: Dec. 5, 2002

(54) Method for cryptographing information

(76) Inventor: Dong-Hyang Lee, Incheon (KR)

Correspondence Address: PENNIE AND EDMONDS, 1155 AVENUE OF THE AMERICAS, NEW YORK, NY, 100362711

(21) Appl. No.: 10/099,763

(22) Filed: Mar. 15, 2002

(30) Foreign Application Priority Data
May 30, 2001 (KR) 2001-30164
Jan. 23, 2002 (KR) 2002-3877

(51) Int. Cl. H04K 3/00

(52) U.S. Cl. 380/1

(57) ABSTRACT

A method for cryptographing information. The information cryptographing method can be executed in a client terminal based on a wired/wireless network. The method comprises the steps of generating a private encryption key and a public key for information encryption, sending the generated public key and an encryption execution module to the client terminal, executing the encryption execution module and the public key in the client terminal to encrypt the information and receiving the encrypted information from the client terminal, and calling the generated private encryption key and decrypting the received encrypted information with the called private encryption key.

### BACKGROUND OF THE INVENTION

1. Field of the Invention

The present invention relates to an system for cryptographing information to be transmitted, and more particularly to a method for cryptographing information, which is capable of encrypting information entered from a client on the Web in a non-installed manner and transmitting the encrypted information.

2. Description of the Related Art

As well known, a log-in technology is widely used to authenticate a user on a general Web site. That is, the login is a technology for determining the validity or not of the user on the basis of data such as a user identification (ID) and password. Because the log-in technology is easily implemented and is managed with no difficulty, it has been positioned as the most fundamental user authentication technology.

However, there is a risk that log-in information can be stolen and garbled by a malicious third party during its transmission in the conventional log-in technology. In order to prevent the above problem from occurring, the concept of authentication and cryptography has been introduced. A manner of employing a typical log-in technology currently used is to install in a client computer private information for authentication, a certificate which verifies that a person corresponding to the private information is authenticated, and a certificate storing an encryption key, called a finger print, for data exchange.

In a network communication, a certificate distribution technology is utilized in combination with a secure socket layer (SSL) which performs encrypted socket communications. This certificate distribution technology has been recently positioned as a standard for secure communications. The SSL is employed by most payment systems in connection with e-business. This SSL performs a mutual authentication (in a public key cryptography such as RSA 1024-bit) between a client and a server, a client computer message digest (by MD-5, SHA-1 or so forth) and transmission of user information which is encrypted (by a symmetric key cryptography such as DES, RC5 or so forth) and then stored. A data format in the SSL is defined by an ITU X.509 international standard.

The SSL has been generalized as an internationally recognized technology because of strong confidence in its safety. In a data processing procedure, the SSL performs several steps for authentication, such as a symmetric key exchange (or a handshake process) using a public key cryptography, a message digest and a transmission of data encrypted with a symmetric key. The symmetric key exchange, referred to as a handshake process, puts a heavy load on a server. The size of authentication data to be transmitted from each user reaches 2 Kbytes. An authentication server has to have an additional module for compiling the authentication data. In this regard, there is a disadvantage in that the authentication server suffers a heavy load. For this reason, the authentication server encounters performance degradation and has a data processing speed and networking speed which both are slightly lower than a server providing no SSL service. In addition to the Web server, a high-price certificate management system needs to be established to manage certificates used in the SSL service. This consumes additional human resources and costs, resulting in a heavy burden on business.

In an inner algorithm aspect of the SSL, the minimum key size of RSA which is a standard algorithm used by the SSL for a key exchange, is 1024 bits required for safety, which key size far larger than the 160 bits of elliptic curve cryptography (ECC). This large key size of the RSA puts a heavy load the server owing to a security level adjustment and data transmission.

According to the certificate issuance method of SSL, the certificate is issued in such a manner that it is installed in the client computer. In the case where the user accesses the authentication server using a different computer, he/she has the inconvenience of having to download a new certificate while discarding the old one because the SSL does not allow the certificate to be doubly issued. Further, in the conventional certificate issuance method, each authentication server issues a different certificate. Therefore, in order to use a specific Web page, the user must be issued with a certificate allowed to be used in the Web page, resulting in a degradation in generality of an authentication device.

Such a degradation in generality may cause a more serious problem in wireless environments which are poor in available device resources and have a relatively low network performance. The SSL or WTLS performing in the same manner as the SSL in the wireless environments functions as a protocol in a transport layer. For this reason, there exists a security vacuum due to a protocol conversion when information requiring security passes through a gateway, and therefore it is difficult to guarantee an end-to-end security. Further, since security activities are not unified in the wireless environments, the server is put under heavy load resulting from managing and carrying out the security activities, and a network performance is compromised.

Secure shell (SSH) is a relatively simpler process of use than the SSL or the like based on a certificate. However, the SSH performs user authentication in such a manner that the certificate is installed in a client computer instead of transplanted to the Web. This results in a trouble of initialization and transplantation to the Web. For this reason, the SSL is not generally used.

### SUMMARY OF THE INVENTION

Therefore, the present invention has been made in view of the above problems, and it is an object of the present invention to provide a method for cryptographing information in a non-installed manner in a user terminal in wired/wireless network communications, which method can authenticate a user without installing a certificate for user authentication.

It is a further object of the present invention to provide an information cryptographing method which can improve a data processing speed and networking speed by reducing the amount of encrypted data sent from a client to a Web server.

It is another object of the present invention to provide an information cryptographing method which can reduce load of a server processing encrypted information.

It is yet another object of the present invention to provide an information cryptographing method which can be implemented with an application program executed on a variety of virtual machine platforms or an operating system (OS).

In accordance with the present invention, the above and other objects can be accomplished by the provision of information cryptographing method, comprising the steps of a) generating a private encryption key and a public key for information encryption; b) sending the generated public key and an encryption execution module to the client terminal; c) executing the encryption execution module and the public key in the client terminal to encrypt the information and receiving the encrypted information from the client terminal; and d) calling the generated private encryption key and decrypting the received encrypted information with the called private encryption key.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a system structure diagram;

FIG. 2 is a flow chart illustrating a procedure of a cryptography operation for user authentication according to the present invention;

FIG. 3 is a flow chart illustrating in detail an encryption module drive operation for generating a public key in FIG. 2;

FIG. 4 is a flow chart illustrating in detail user information encryption and message digest operations in FIG. 2, which are performed by a client terminal;

FIG. 5 is a flow chart illustrating in detail a user information decryption operation in FIG. 2, which is performed by a Web authentication server;

FIG. 6 shows a flow chart of a payment system server performing a payment operation using a method for encrypting user authentication information according to the present invention; and

FIG. 7 is a view showing an example where the user authentication information cryptographing method is performed in a wireless network system.

### DESCRIPTION OF THE PREFERRED EMBODIMENTS

Preferred embodiments of the present invention will be described herein below with reference to the accompanying drawing. In the following description, well-known constructions or functions such as an elliptic curve cryptography (ECC) algorithm are not described in detail since they would obscure the invention with unnecessary detail. Hereinafter, a description will be given of an information cryptographing method according to a preferred embodiment of the present invention on the basis of an example of user authentication information and payment information.

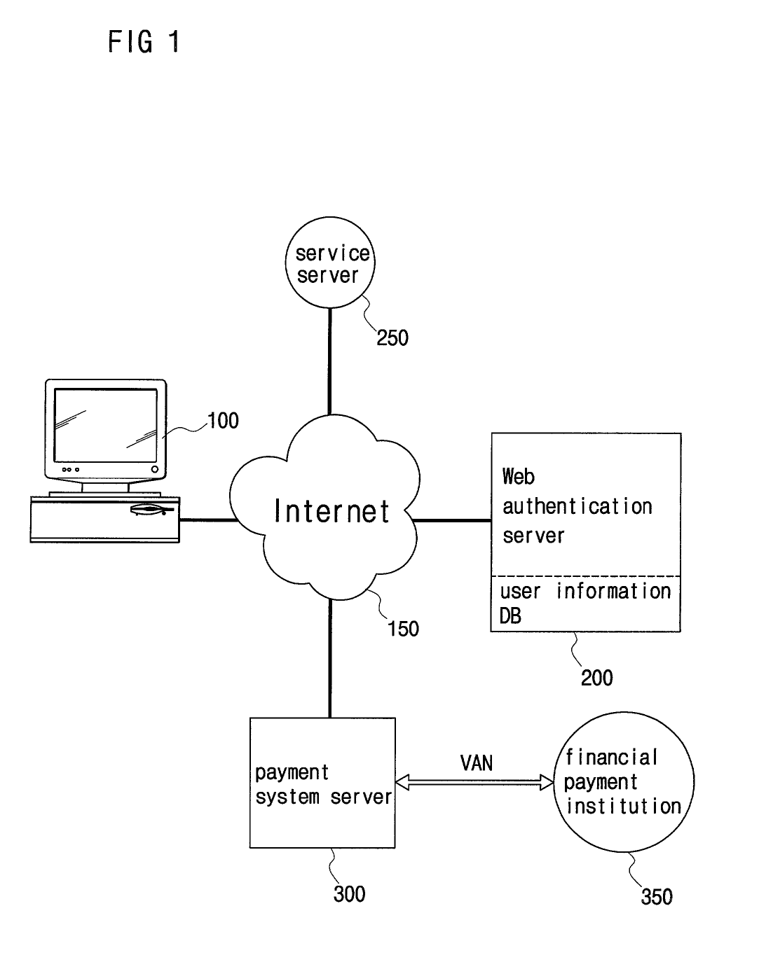

FIG. 1 shows a system structure diagram in accordance with the preferred embodiment of the present invention. As shown in this drawing, a client terminal 100 is connectable to a Web authentication server 200, service server 250 and payment system server 300 through the Internet 150. The name of the Web authentication server is given to the server 200 for the purpose of describing an embodiment for authenticating a user. The server 200 may be also termed a cryptography server which means that it performs entire encryption and decryption operations.

The Web authentication server 200 includes a user information database (DB). The server 200 acts to provide the client terminal 100 with a log-in page containing an encryption execution module when receiving an access request from the client terminal 100. The encryption execution module includes a public key generated by an encryption module, a message digest module (such as SHA-1) and a data compression module. Further, the Web authentication server 200 functions to receive user information subjected to the encryption, message digest and data compression processes, perform a digest release operation and decryption with respect to the received user information. Then, the Web authentication server 200 functions to execute a user authentication by comparing the decrypted user information with prestored user information.

The service server 250 functions to provide service information requested by a user-authenticated client. The service server 250 may be a shopping mall. The payment system server 300 is connectable to a server of a financial payment institution 350 through a VAN or a dedicated computer network. The payment system server 300 functions to provide the client terminal 100 connected thereto through a mediation of the service server 250 with a payment Web page containing an encryption execution module including the public key generated by the encryption module, a message digest module and a data compression module. Further, the payment system server 300 functions to receive payment information such as a card number and password, which is decrypted and data compression-processed through the encryption execution module, decompress/decrypt the received payment information and send the decompressed/decrypted payment information to the server of the financial payment institution 350. After the sending of the payment information, the payment system server 300 functions to receive payment approval result information from the server of the financial payment institution 350 and send the received payment approval result information to the client terminal 100, thereby allowing the client to receive payment approval information or payment rejection information.

Hereinafter, a description will be given of a user authentication cryptography operation and its application to a payment system.

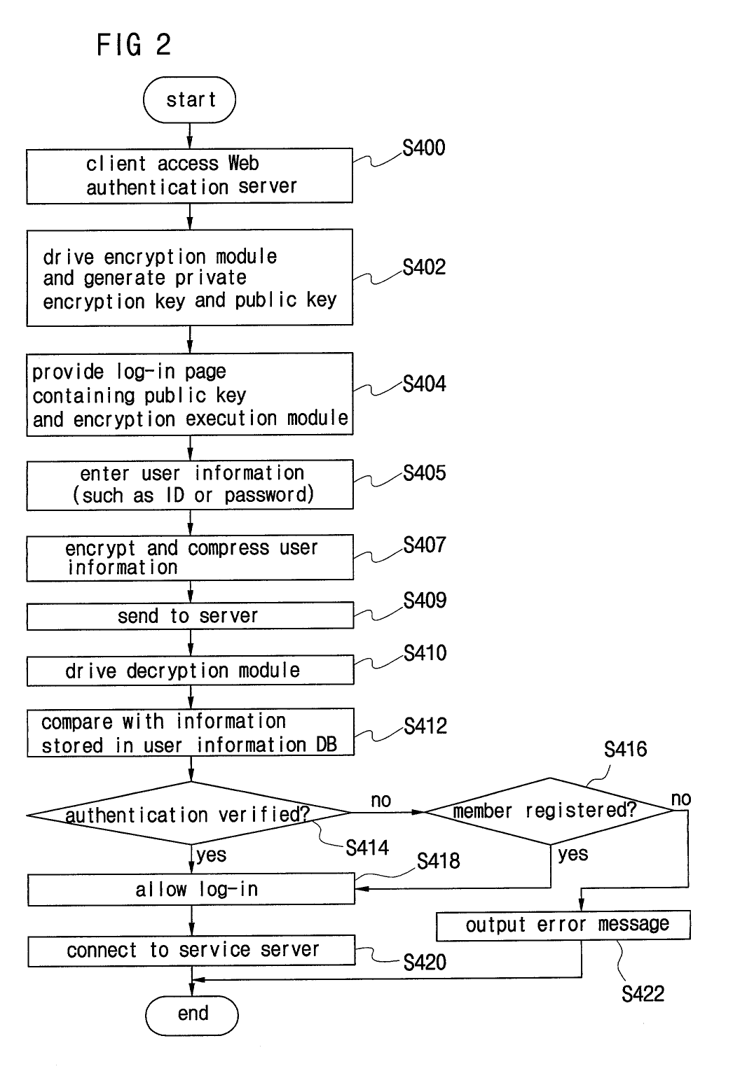

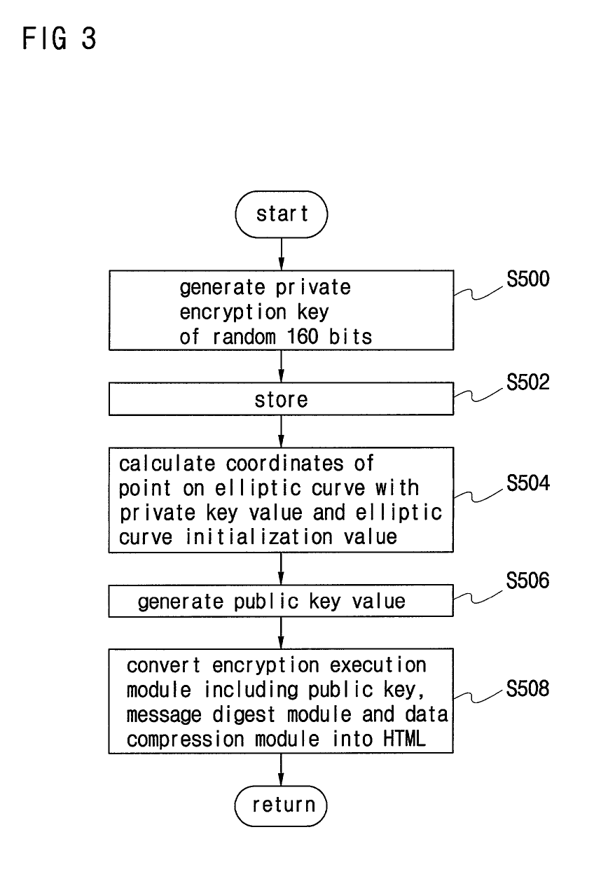

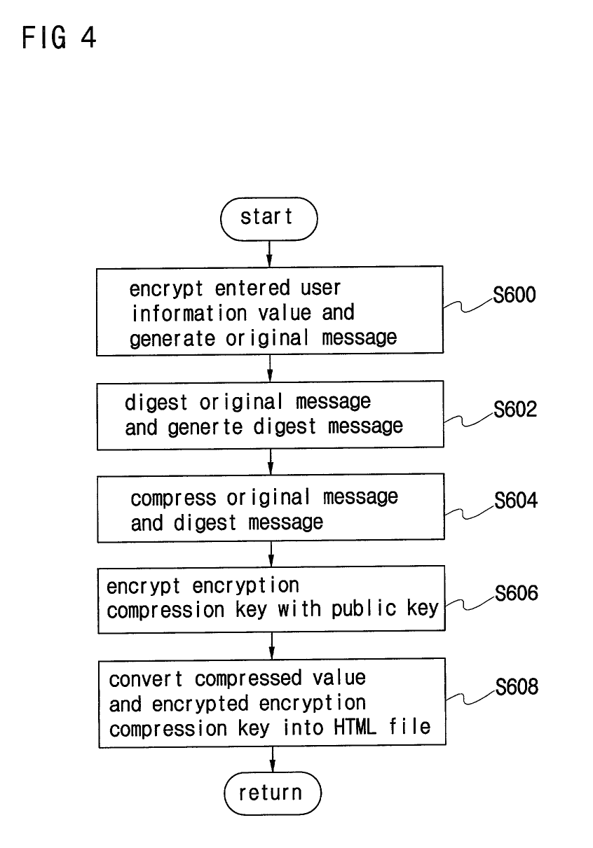

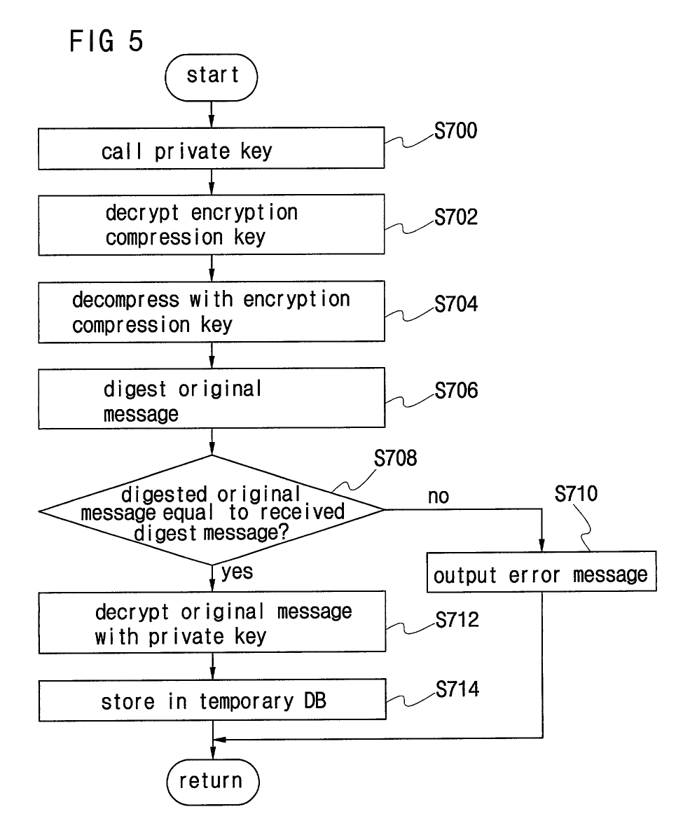

FIG. 2 is a flow chart illustrating a procedure of a cryptography operation for user authentication according to a preferred embodiment of the present invention. FIG. 3 is a flow chart illustrating in detail an encryption module drive operation for generating a public key in FIG. 2. FIG. 4 is a flow chart illustrating in detail user information encryption and message digest operations in FIG. 2, which are performed by the client terminal 100. FIG. 5 is a flow chart illustrating in detail a user information decryption operation in FIG. 2, which is performed by a Web authentication server 200.

In FIG. 2, even reference numerals denote steps performed by the Web authentication server 200, and odd reference numerals denote steps performed by the client terminal 100. With reference to this drawing, first, the client terminal 100 sends a request to the Web authentication server 200 to gain access thereto (S400). When receiving the access request from the client terminal 100, the Web authentication server 200 drives the encryption module to generate a public key (S402) according to an event owing to the access request. In more detail, as shown FIG. 3, the encryption module generates a private encryption key of 160 random bits in response to the access request from the client terminal 100 (S500) and stores the generated private encryption key in a key management DB (S502). Then, the encryption module calculates coordinates of a point on an elliptic curve using the private encryption key and an elliptic curve initialization value (S504) and generates the public key to be sent to the client terminal 100. Sequentially, the encryption module converts into an HTML file the encryption execution module including the generated public key, the message digest module for an integrity verification, and the data compression module for reduction of transmission data (S508). After this, the Web authentication server 200 returns to its main routine. In summary, at the above step 402, the Web authentication server 200 generates the public key for a user information encryption on the basis of an ECC algorithm.

It is noted that a message digest method is used in the integrity verification in the embodiment of the present invention. In an integrity verification procedure, it is determined whether data is garbled (changed or compromised by noise or a malicious third party) during its transmission. For this, first, a client side generates a digest message of a given length from an original message by operating a message digest algorithm such as MD5 or SHA1 and sends the generated digest message with the original message to a server side. On the other hand, the server side generates a digest message from the sent original message with the same message digest algorithm as the client side. Then, the server side verifies that the original message is not garbled during its transmission by comparing this newly generated digest message with the sent digest message. Notice that the MD5 algorithm is designed to generate a 36 bit digest message while the SHA1 algorithm generates a 40 bit digest message. For this reason, the probability of being able to circumvent the message digest of the SHA1 is higher than that of the MD5. Therefore, the SHA1 is more effective than the MD5 in security. In the embodiment of the present invention, the data compression module is used for reduction of transmission data and double security. The data compression module is assigned an encryption key value which is generated by arbitrarily selecting a part (such as four numbers) among a public key used in encryption. The encryption key value is encrypted with the public key from which it is extracted to guarantee security thereof during its transmission. Hereinafter, the encryption key value is defined as an encryption compression key.

Referring again to FIG. 2, Web authentication server 200 provides the client terminal 100 with a log-in page containing the encryption execution module including the public key generated by deriving the encryption module, a message digest module (using the SHA1 algorithm) and a data compression module. The encryption execution module acts to encrypt the public key, a random integer of 14 bits, and user information by implementing elliptic curve arithmetic. The message digest module acts to digest a given message. The data compression module acts to compress the results of operations of these two modules and can be selectively contained in the log-in page. In the present invention, all of the above mentioned modules are contained in the log-in page in the form of a Java applet.

As described above, in the present invention, the Web authentication server 200 generates the private encryption key and the public key used in user information encryption which is executed using the elliptic curve arithmetic. Further, the Web authentication server 200 provides a Web page, or the login page, under the condition that the generated public key and encryption execution module are included therein, as described above.

On the other hand, a user of the client terminal 100 is provided with the log-in page form the server 200 and enters his/her identification (ID) and password, which both are user information, in a user information input field of the provided log-in page (S405). After this, if the user clicks on a confirm button, the user information encryption and data compression are executed with respect to the entered user information by the encryption execution module contained in the log-in page (S407). This user information encryption and data compression procedures will be described in detail below with reference to FIG. 4.

At step 600 in FIG. 4, the encryption execution module generates an original message by encrypting a value of the entered user information with the public key. At step 602, the encryption execution module generates a digest message to guarantee message integrity by digesting the original message using the message digest module. Then, the encryption execution module compresses both of the original message and digest message for reduction of transmission data and double encryption, or the double security using the data compression module (S604). In order to compress both of the original and digest messages, first, the encryption execution module randomly selectively extracts as many numbers (hereinafter, “encryption compression key”) from the public key as predetermined numbers, and then compresses both of the original and digest messages with the extracted encryption compression key. Thereafter, the encryption compression key is encrypted with the public key with which the original message is encrypted in order to safely send the encryption compression key (S606). The encrypted encryption compression key is converted into a Web document together with a value, or the digest message, compressed at step 604. Then, the control procedure is returned to a main routine.

Referring again to FIG. 2, the user information encrypted and compressed at the above step 407 is sent to the Web authentication server 200 at step 409.

At step 410, the Web authentication server 200 decrypts the encrypted/compressed user information by calling and driving a decryption module. A description of an operation of the decryption module will be given in detail below with reference to FIG. 5. First, the decryption module calls the private encryption key at step 700 and decrypts the encrypted encryption compression key with the called private encryption key at step 702. At step 704, the decryption module decompresses the compressed original message and digest message from the client terminal 100 using the decrypted encryption compression key. Thereafter, the decompressed original message is digested to produce a digest message at step 706. When the digest message corresponding to the sent original message is produced at step 706, the newly produced digest message is compared to the digest message from the client terminal 100 to determine whether they are the same at step 708.

If it is determined at step 708 that they are the same, or if the integrity of the original message is verified, the decompressed original message is decrypted with the previously called private encryption key at step 712 and then stored in a temporary DB at step 714. Alternatively, if the integrity of the original message is not verified, an error message is outputted at step 710.

Referring again to FIG. 2, at step 412, the Web authentication server 200 compares information stored in the user information DB with the decrypted original message which is stored in the temporary DB through the above decryption steps to authenticate the user of the client terminal 100. At step 414, it is determined whether the user is authenticated. If the user is normally authenticated, the server 200 proceeds to step 418 to allow the user to log in and connects the client terminal 100 to the service server 250 at step 420. On the other hand, if the user is not authenticated, the server 200 invites the user to register as a member thereof. If the user is registered in the server 200 at step 416, the server 200 proceeds to step 418 to allow the user to log in. Alternatively, if the user rejects member registration at step 416, the server 200 outputs an error message to the client terminal 100 at step 422.

As described above, in the present invention, in order to encrypt the user information transmitted between the client and the server, the log-in page containing the encryption execution module is sent to the client terminal to perform encryption and data compression with respect to the user information, rather than using an algorithm installed in the client terminal for user information encryption. Therefore, the user can access the Web without any procedure adapting him/her to a change of a server system. Further, the user can safely log in using any other computer besides his/her own computer during its program upgrade.

Up to now, a description has been given of the information encryption method for the user authentication according to the preferred embodiment of the present invention. Hereinafter, a payment information encryption method will be described.

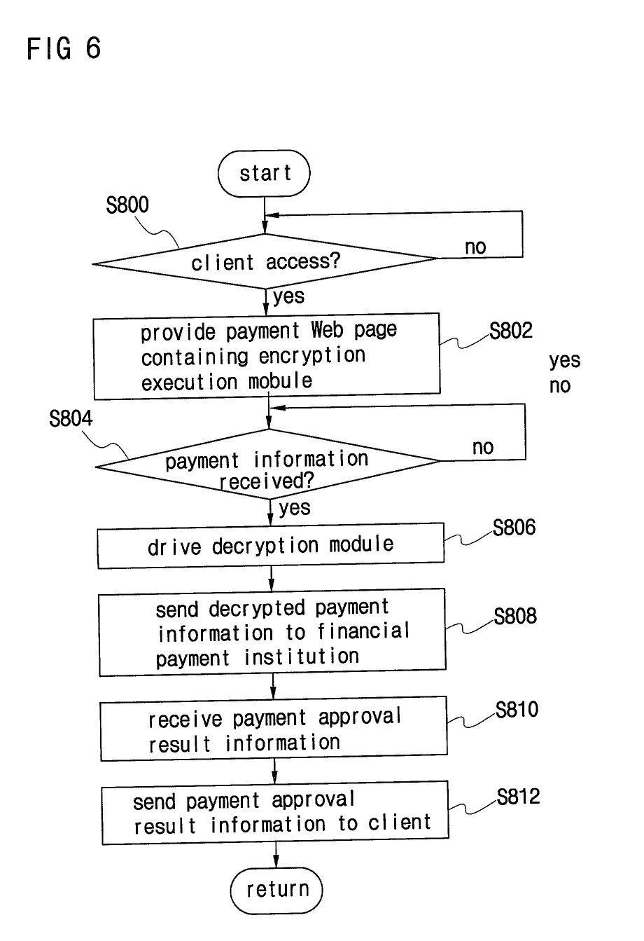

FIG. 6 shows a flow chart of the payment system server 300 performing a payment information encryption according to a preferred embodiment of the present invention.

When the user authentication is completed through the procedures of FIG. 2, the Web authentication server 200 allows the client terminal 100 to be connected to the service server 250 connected thereto. The service server 250 connects the client terminal 100 to the payment system server 300 if the client accesses a payment page during use of a service. If the user authentication is completed by the payment system server 300 through the procedures of FIG. 2, the client terminal 100 is directly connected to the payment system server 300. If it is determined at step 800 that the client server 100 is connected to the payment system server 300 in such a manner, the payment system server 300 proceeds to step 802 to provide the client terminal 100 with a payment Web page containing an encryption execution module including a public key, message digest module and data compression module, as described above with reference to FIG. 2.

At this time, the client enters payment information such as a card number and password in corresponding payment information input fields provided on the payment Web page. Subsequently, if the user selects a confirm button on the payment Web page, then the payment information entered from the user is encrypted, message-digested and compressed by the encryption execution module, as described above with reference to FIG. 2, and then sent to the payment system server 300. The payment system server 300 determines whether the encrypted and compressed payment information is received thereto at step S804. If the encrypted and compressed payment information is received, the server 300 proceeds to step 806 to call and drive a decryption module. The decryption module first decrypts an encryption compression key with a private encryption key and decompresses an original message from the client terminal 100 with the decrypted encryption compression key. Subsequently, the decryption module digests the decompressed original message to produce a digest message. The newly produced digest message is compared to a digest message sent from the client terminal 100 to verify the integrity of the original message. If the integrity of the original message is successfully verified, the original message is decrypted with the private encryption key and, as a result, the payment information entered by the client is restored.

Then, the payment information is sent to the server of the financial payment institution 350 for payment approval at step 808. After this, the payment system server 300 receives payment approval result information from the server of the financial payment institution 350 at step 810. If receiving the payment approval result information, the payment system server 300 sends this information to the client terminal 100 at step 812. The client can take measures such as reentering a payment information, service provision request and the like according to the payment approval result information from the server 300.

The present invention introduces an information cryptographing method employing a non-installed method for payment in the course of electronic commerce, and raises an encryption level. The information cryptographing method of the present invention has superiority over the conventional SSL technology in speed and can reduce load inflicted on a server.

Up to now, the method for cryptographing user authentication information and payment information in a most popular wired network has been described. The present invention can be implemented in a wireless network system without particular modification. This will be described in detail below.

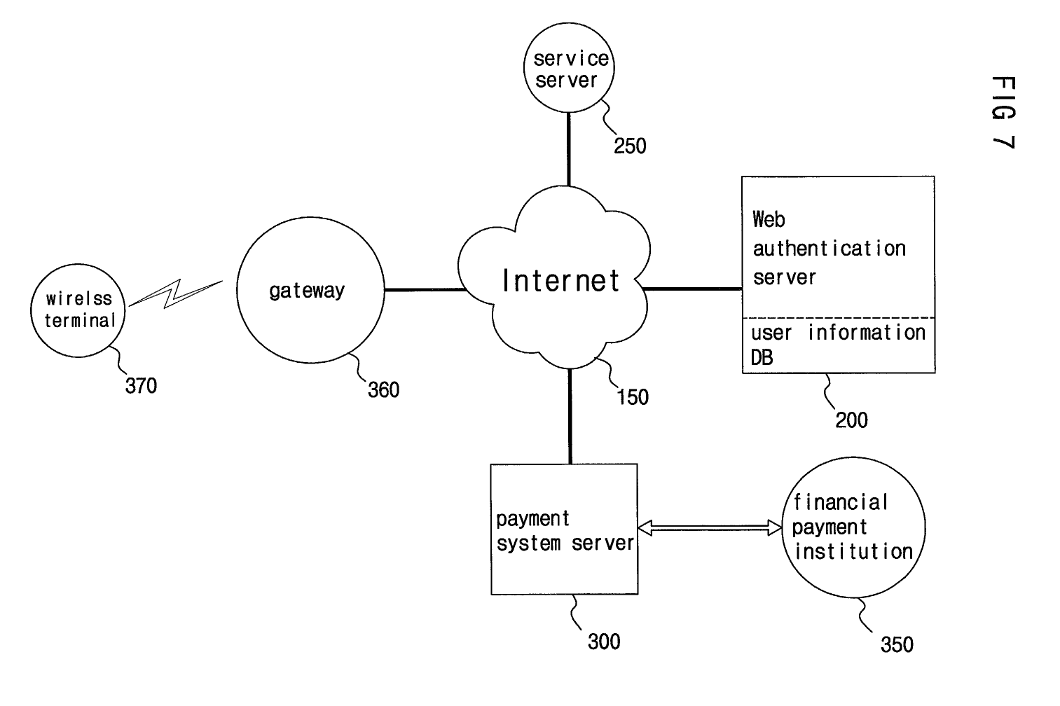

FIG. 7 is a view showing an example where the user authentication information cryptographing method is used in a wireless network system. A wireless terminal 370 such as a PDA or mobile telephone can communicate data with a gateway 360 using a wireless application protocol (WAP). The gateway 360 can be connected to the Web authentication server 200 through the Internet 150 based on a hypertext transfer protocol (HTTP). The Web authentication server 200 performs the same functions as the Web authentication server in FIG. 1. Further, other components denoted by reference numerals 250, 300 and 350 perform the same functions as the blocks in FIG. 1. A detailed description thereof will thus be omitted.

A description will be given of an Internet connection procedure in a general wireless network. The wireless terminal 370 has to be connected to the gateway 360 first of all in order to be connected to the Internet 150. The wireless terminal 370 can communicate with the gateway 360 based on a wireless transport layer security (WTLS) protocol.

The gateway 360 connected to the wireless terminal 370 searches for a uniform resource locator (URL) to try a request to access a corresponding Web server, for example, the Web authentication server 200. In this case, the gateway 360 performs SSL communications with the Web authentication server 200.

In the case of communications from the Web authentication server 200 to the wireless terminal 370 or vice versa, a cipher is instantaneously deciphered in the gateway 360 and then is re-encrypted. The gateway 360 changes a ciphertext to a plaintext and then again changes the plaintext to the ciphertext to send the cipertext. For this reason the gateway is burdened with a heavy load. This makes networking speed lower, and a security hole may be exposed.

However, in the case where the information cryptographing method according to the preferred embodiment of the present invention is used, there is no need for the gateway 360 to invert information from a user terminal, or the wireless terminal, to a plaintext, and to encrypt the plaintext when sending the information form the user terminal to the Web authentication server 200. The gateway 360 experiences no heavy burden. As a result, a high-speed networking is enabled and security can be continuously maintained.

In this regard, it can be said that the present invention is more effective in wireless Internet access environments.

As apparent from the above description, the present invention provides an information cryptographing method employing a non-installed method. The present invention can easily raise the level of encryption by raising an encryption level of ECC which is used in an encryption level upgrade. In the present invention, data transmitted between a client and a server is encrypted and, further, a part of keys used in encryption is used again to compress encrypted contents. Therefore, the present invention is advantageous in that the amount of data to be transmitted can be reduced and double security is achieved. Because the size of encrypted data is small, data process and networking speeds are higher than those of a conventional SSL method, and a server is not burdened with a heavy load. Because the information cryptographing method of the present invention is performed at an application layer, it is possible to analyze information to be transmitted and to selectively encrypt/transmit important information. For this reason, the server's burden becomes small compared to that of the conventional SSL. In the present invention, because encryption modules are implemented in the form of Java applet or ActiveX, they can be used regardless of a Web browser or server, and they are easily implemented using applet application. The present invention provides an advantage of not requiring establishment of an additional server for a security set.

In the present invention, a certificate is not installed in a user computer and, therefore, a user of the computer can safely log in using any other computer besides his/her own computer during its program upgrade. Further, the user is not inflicted with additional burden resulting from an increase of server's capacity when there is a change of an authentication system.

In the present invention, the user can access the Web without any procedure adapting him/her to a change of a server system. This allows the user to be able to use newly changed facts without particular measures. In the case of the change of the server system, the user has to purchase a solution for a certificate management if the SSL is used. On the other hand, the use can more easily manage a certificate if the information cryptographing method of the present invention is used.

In the present invention, where a wireless terminal communicates with a Web authentication server in wireless Internet access environments, a gateway needs not change a ciphertext to a plaintext and needs not encrypt the plaintext again, resulting in an increase in wireless networking speed as well as reduction in gateway's load.

Although the present invention have been described disclosed in connection with specific preferred embodiments, it should be understood that the invention as claimed should not be unduly limited to such specific embodiments, and those skilled in the art will appreciate that various modifications, additions and substitutions are possible. For example, in the preferred embodiments of the present invention, user information for user authentication or payment information for a payment is encrypted. However, this information is taken as an example of information required encryption, and the present invention is not limited to this.

What is claimed is:

1. A method for cryptographing information, which is executed in a server connectable to a terminal of a client through a network, the method comprising the steps of:
a) generating a private encryption key and a public key for information encryption;
b) sending the generated public key and an encryption execution module to the client terminal;
c) executing the encryption execution module and the public key in the client terminal to encrypt the information and receiving the encrypted information from the client terminal; and
d) calling the generated private encryption key and decrypting the received encrypted information with the called private encryption key.

2. The method as set forth in claim 1, wherein the encrypted information is user authentication information required to log in and wherein the method further comprising the steps of:
e) comparing the decrypted information with prestored information; and
f) allowing or denying access of the client according to a result of information authentication

3. The method as set forth in claim 1, wherein the encrypted information is payment information and wherein the method further comprising the steps of:
e) sending the decrypted information to a connectable financial payment institution server; and
f) receiving payment approval result information from the financial payment institution server and sending to the client terminal the received payment approval result information;

4. The method as set forth in any one of claims 1 to 3, wherein the public key is generated by calculating coordinates of a point on an elliptic curve with a private encryption key value of n bits and an elliptic curve initialization value.

5. The method as set forth in any one of claims 1 to 3, wherein the step d) includes the steps of:
d-1) decrypting an encryption compression key contained in the encrypted information with the called private encryption key;
d-2) decompressing an original message and a digest message with the decrypted encryption compression key;
d-3) digesting the decompressed original message; and
d-4) comparing the digested original message with the digest message and, if the digested original message and the digest are the same, decrypting the decompressed original message with the private encryption key.

6. A method for cryptographing information, which is executed in a computer connectable to a gateway communicating with at least one wireless terminal, the method comprising the steps of:
a) generating a private encryption key and a public key for information encryption;
b) sending the generated public key and an encryption execution module to the wireless terminal;
c) executing the encryption execution module and the public key in the wireless terminal to encrypt the information and receiving the encrypted information from the wireless terminal through the gateway; and
d) calling the generated private encryption key and decrypting the received encrypted information with the called private encryption key.

7. The method as set forth in claim 6, wherein the step d) includes the steps of:
d-1) decrypting an encryption compression key contained in the encrypted information with the called private encryption key;
d-2) decompressing an original message and a digest message contained in the encrypted information with the decrypted encryption compression key;
d-3) digesting the decompressed original message; and
d-4) comparing the digested original message with the digest message and, if the digested original message and the digest message are the same, decrypting the decompressed original message with the private encryption key.

8. A method for cryptographing information, which is downloaded together with a public key from an encryption server through a network and executed in a wired/wireless terminal of a client, the method comprising the steps of:
a) encrypting the information entered from a client with the public key to generate an original message;
b) digesting the encrypted original message;
c) compressing the original message and the digested original message with an encryption compression key under the condition that the encryption compression key is generated by randomly extracting a part of the public key;
d) encrypting the encryption compression key with the public key having been used to encrypt the original message; and
e) converting the compressed original message, the compressed digested original message and the encrypted encryption compression key into Web documents and sending the Web documents.
